(19) United States
(12) Patent Application Publication
(10) Pub. No.: US 2019/0232865 A1
(43) Pub. Date: Aug. 1, 2019

(54) DISPLAY DEVICE AND MOUNTING STRUCTURE OF VEHICLE METER

(71) Applicant: HONDA MOTOR CO., LTD., Tokyo (JP)

(72) Inventor: Hayato Kawakami, Wako-shi (JP)

(21) Appl. No.: 16/251,155

(22) Filed: Jan. 18, 2019

(30) Foreign Application Priority Data
Jan. 26, 2018 (JP) 2018-012047

(51) Int. Cl. B60Q 3/18; B60Q 3/14; G01D 11/28; B60Q 3/51

(52) U.S. Cl. CPC B60Q 3/18; B60Q 3/51; G01D 11/28; B60Q 3/14

(57) ABSTRACT

There is provided a display device (1) including a display (30), a decorative portion (50) which covers an outer circumferential portion of the display, and a light detector (70) which is provided in contact with or in proximity to the decorative portion and is configured to detect an amount of light guided by the decorative portion.

### CROSS-REFERENCE TO RELATED APPLICATION

Priority is claimed on Japanese Patent Application No. 2018-012047, filed Jan. 26, 2018, the content of which is incorporated herein by reference.

### BACKGROUND OF THE INVENTION

### Field of the Invention

The present invention relates to a display device and a mounting structure of a vehicle meter.

### Description of Related Art

Conventionally, a technique for displaying an image of a vehicle meter on a display instead of a mechanical vehicle meter is known (for example, Japanese Unexamined Patent Application, First Publication No. 2017-149182 and Japanese Unexamined Patent Application, First Publication No. 2006-329711).

### SUMMARY OF THE INVENTION

A display (a display device) that shows a user an image by emitting light looks different according to the amount of external light. For example, in the case in which the amount of external light is large, for example, a case in which direct sunlight is incident, it is difficult to see an image when luminance of the display device is low. In the technique described in Patent Document 1, it was impossible to adjust the luminance of the display according to the amount of radiated light. Further, in the technique described in Patent Document 2, since a hole is provided at a position which is visible to a driver, an exterior of the vehicle meter may be impaired. An aspect of the present invention has been made in view of the above-described problems, and it is an object of the present invention to provide a display device and a mounting structure of a vehicle meter capable of appropriately detecting an amount of radiated light while maintaining a design of the device itself.

The display device and the mounting structure of the vehicle meter according to the present invention employ the following constitution.

(1): A display device according to one aspect of the present invention is a display device including a display, a decorative portion which decorates the display, and a light detector which is provided in contact with or in proximity to the decorative portion and is configured to detect an amount of light guided by the decorative portion.

(2): In the aspect of (1), the display may display an image recognized as a vehicle meter.

(3): In the aspect of (1) or (2), the display device may further include a controller which is configured to change a luminance of the display on the basis of a detection result of the light detector.

(4): In the aspects of (1) to (3), the display may be mounted together with a mechanical display mechanism.

(5): In the aspects of (1) to (3), the display may include a mechanical display mechanism and may display a physical quantity relating to a traveling state of a vehicle.

(6): In the aspects of (1) to (5), the decorative portion may protrude outward from a display surface of the display.

(7): In the aspects of (1) to (6), the display device may further include an irradiator which is configured to irradiate the decorative portion with light and thereby emit light and decorate a display surface of the display.

(8): In the aspect of (7), the display device may further include a difference acquisition unit which is configured to acquire a value obtained by subtracting an amount of light radiated by the irradiator from the detection result detected by the light detector as an amount of external light.

(9): In the aspects of (1) to (8), the light detector may be provided on a back surface side of the decorative portion.

(10): A mounting structure of a vehicle meter according to present invention is a mounting structure of a vehicle meter, wherein a decorative portion configured to decorate a display is mounted, and a light detector configured to detect an amount of light guided by the decorative portion is provided in contact with or in proximity to a back surface of the decorative portion.

According to the aspects of (1) to (10), the amount of radiated light can be appropriately detected.

According to the aspect of (3) or (5), it is possible to change the luminance of the display according to light in the surrounding environment of the vehicle so that the display can be adjusted to be easily seen by a driver.

According to the aspect of (4), although the difficulty in viewing of the display is emphasized by being installed together with the mechanical display mechanism, this can be alleviated.

According to the aspect of (7), it is possible to decorate the display and to enhance a design.

According to the aspect of (8), it is possible to appropriately detect an amount of radiated light even when the display is decorated.

According to the aspect of (9), it is possible to make the light detector hard for the user to see, and it is possible to improve a design.

According to the aspect of (10), it is possible to provide a vehicle meter which can maintain high visibility.

### BRIEF DESCRIPTION OF THE DRAWINGS

FIG. 1 is a front view of a display device according to an embodiment.

FIG. 2 is a perspective view of the display device according to the embodiment.

FIG. 3 is a diagram showing an example of a decorative portion according to the embodiment.

FIG. 4 is a cross-sectional view taken along line A-A′ in FIG. 1.

FIG. 5 is a diagram showing an example of a functional constitution of a controller of the display device of the embodiment.

FIG. 6 is a diagram showing an example of light amount luminance correspondence information of the embodiment.

FIG. 7 is a diagram showing an example of a detection result by a light detector of the embodiment.

FIG. 8 is a flowchart showing an example of processing of the controller according to the embodiment.

FIG. 9 is a front view of a display device according to a modified example.

FIG. 10 is a diagram showing an example of a functional constitution of a controller of the display device according to the modified example.

### DETAILED DESCRIPTION OF THE INVENTION

### Embodiment

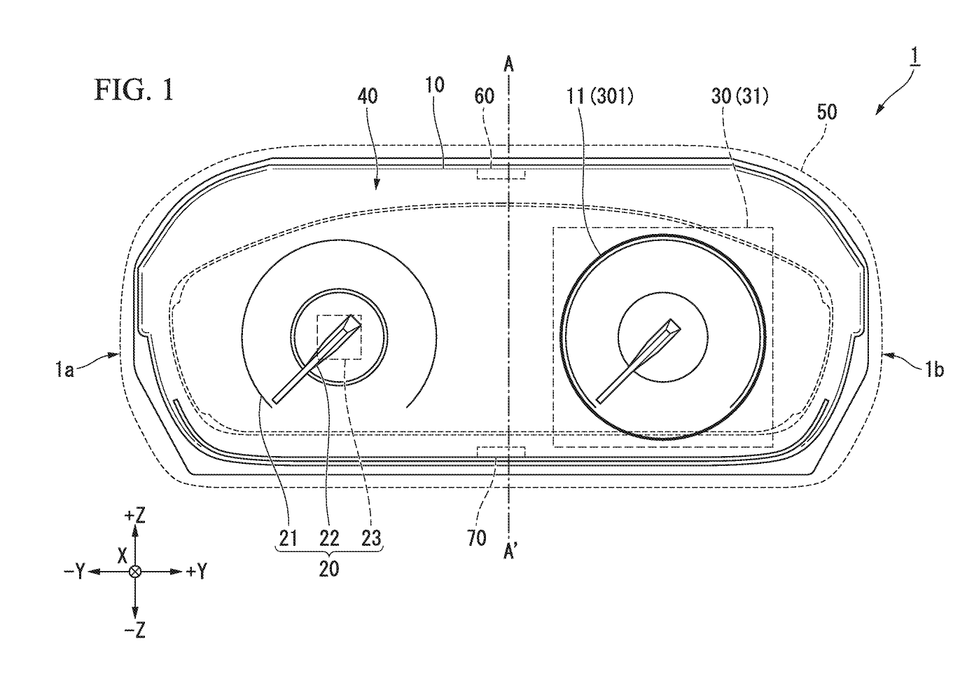

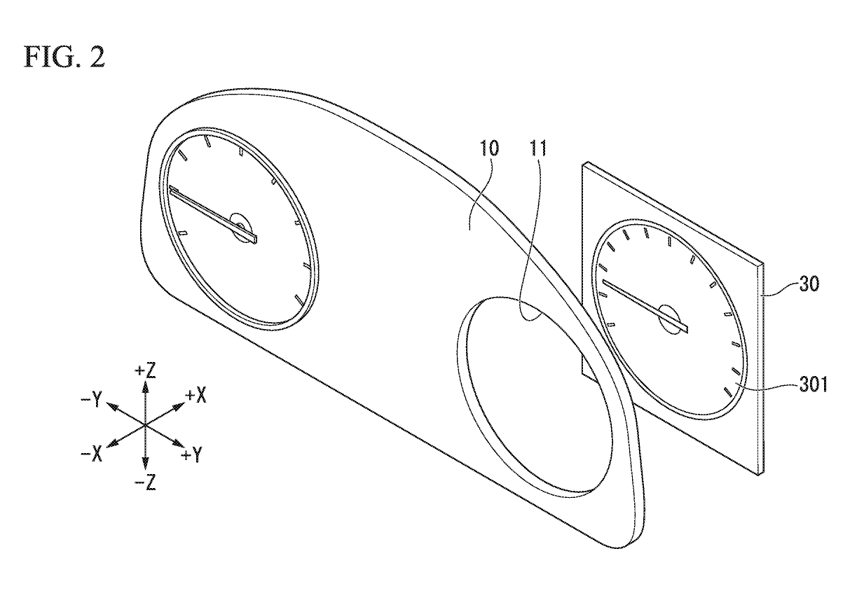

Hereinafter, an embodiment of the present invention will be described with reference to the drawings. FIG. 1 is a front view of a display device 1 according to an embodiment. FIG. 2 is a perspective view of the display device 1 according to the embodiment. The display device 1 is a device which adjusts a luminance of a display surface according to an amount of light radiated on the display surface. In the following embodiment, the display device 1 is mounted in a vehicle, displays information on the vehicle and provides the information to a driver, but the present invention is not limited thereto, and the display device 1 may be used for other purposes.

The display device 1 includes, for example, a display plate 10, an analog meter 20, a display panel 30, a cover 40, a decorative portion 50, an irradiator 60, and a light detector 70.

Here, an X direction, a Y direction, and a Z direction will be defined. The Y direction and the Z direction are directions along the display surface of the display panel 30. The Z direction is a direction orthogonal to the Y direction. A positive Z direction is an upward direction in FIG. 1 in a positive Y direction. The positive Z direction is also referred to as “up” or “upward.” A negative Z direction is a direction opposite to the positive Z direction. The negative Z direction is referred to as “down” or “downward.” In cases in which the positive Z direction and the negative Z direction are not distinguished from each other, they are referred to as the “Z direction” or “vertical direction.” The X direction is a direction orthogonal to the Y direction and the Z direction and is a direction which is slightly downward from a traveling direction of the vehicle.

The display panel 30 displays an image. The display panel 30 is realized by, for example, a liquid crystal display panel, a plasma display panel, an organic electro luminescence (EL) display panel, or the like. The display panel 30 is provided on the right side of the display device 1 as seen by a driver. An image showing information on a vehicle in which the display device 1 is mounted (hereinafter referred to as vehicle information), such as that displayed on a vehicle meter, is displayed on the display panel 30. The vehicle information is, for example, state information which indicates a state of the vehicle, traveling information on a traveling state of the vehicle, environment information on an environment in which the vehicle travels, and so on. The state information is information indicating, for example, a remaining amount of fuel, a water temperature in a radiator, a lighting state of a headlight, and so on. The traveling information is, for example, information indicating a speed of the vehicle, and the number of revolutions of an engine. The environmental information is information indicating, for example, a speed limit detected for a road on which the vehicle travels, and an outside air temperature and the weather. The display panel 30 includes, for example, a controller 31. The controller 31 generates an image signal for displaying an image indicating the vehicle information on the display panel 30. The image signal is output from the controller 31 to the display panel 30. The display panel 30 displays the image indicating the vehicle information according to the image signal.

The analog meter 20 indicates the vehicle information and provides it to the driver. The vehicle information indicated by the analog meter 20 is, for example, the state information indicating the state of the vehicle, the traveling information on the traveling state of the vehicle, the environmental information on the environment in which the vehicle travels, and so on. The analog meter 20 is provided on the left side of the display panel 30 as seen by the driver. The analog meter 20 includes, for example, a ring 21, a pointing needle 22, and an actuator 23. The pointing needle 22 is rotated by the actuator 23 within a region surrounded by the ring 21. Indicators (for example, scale marks or numerals) indicating physical quantities relating to the traveling state of the vehicle on which the display device 1 is mounted are displayed in the region surrounded by the ring 21.

As an example, on the display panel 30, an image indicating the number of revolutions of the engine is displayed in a partial region (an image display region 301 shown in the drawing) of the display surface of the display panel 30. An image indicating the number of revolutions of the engine is an example of an image recognized as the vehicle meter. The speed of the vehicle is indicated in the analog meter 20. Specifically, the actuator 23 rotates the pointing needle 22 on the basis of an input from a sensor which detects the speed of the vehicle. The scale marks indicating the speed of the vehicle are attached to the analog meter 20, and the speed of the vehicle is indicated by a position of the pointing needle 22 with respect to the scale marks. The analog meter 20 is an example of a mechanical display mechanism. The display panel 30 may be provided on the left side as seen by the driver, and the analog meter 20 may be provided on the right side as seen by the driver. The display device 1 may have a constitution in which the display panel 30 is disposed at a center thereof.

The display plate 10 is a member which supports the display panel 30 and the analog meter 20 and allows the driver to visually recognize a part of the display panel 30. The display plate 10 has a hole 11 passing therethrough in the X direction. The hole 11 makes a part of the display panel 30 visible to the driver. In this case, the portion which is visually recognized through the hole 11 is the image display region 301. Therefore, the display plate 10 shields a part of the display panel 30. The display plate 10 includes, for example, a flat surface (hereinafter referred to as a first surface 10a) and a flat back surface (hereinafter referred to as a second surface 10b). Among the surfaces of the display plate 10, the first surface 10a is a surface on the side of the driver. The second surface 10b is a surface on the side of the display panel 30. The analog meter 20 is provided on the first surface 10a. An adhesive is applied to the second surface 10b, and the display plate 10 is bonded to a region of the display panel 30 other than the image display region 301. The display panel 30 may be fixed to the display plate 10 by screwing, caulking, welding or the like.

The display panel 30 may have a shape which coincides with a shape of the hole 11 (in the shown example, a round shape). The display plate 10 may have a constitution in which a member having high light transmittance is fitted into the hole 11. In this case, the portion visually recognized through the member having high light transmittance is the image display region 301.

For example, the decorative portion 50 is mounted to surround at least a part of an outer circumferential portion of the display plate 10 in a Z-Y plane. The decorative portion 50 is formed of, for example, a semitransparent material as a whole. The semitransparent material is, for example, a material which absorbs or diffusely reflects a part of light radiated on the material and emits light different from the radiated light. Edging of the display plate 10 is decorated by the decorative portion 50, and a design of display of the display device 1 can be enhanced. The irradiator 60 irradiates the decorative portion 50 with light. The irradiator 60 is, for example, a light emitting diode (LED) light. Some of the light radiated by the irradiator 60 advances while diffusely reflecting the interior formed by a thickness of the decorative portion 50, and some of the light is emitted to the outside of the decorative portion 50. Therefore, the entire decorative portion 50 emits light in a desired color. Thus, the decorative portion 50 can enhance the design of the display of the display device 1.

A bezel 12 is a casing which defines a space in which the display plate 10, the analog meter 20, the display panel 30, the decorative portion 50, the irradiator 60, and the light detector 70 are accommodated.

The cover 40 closes an opening of the bezel 12. The display plate 10, the analog meter 20, the display panel 30, the decorative portion 50, the irradiator 60, and the light detector 70 are supported by the bezel 12 or the respective parts supported by the bezel 12 and are disposed between the bezel 12 and the cover 40. The bezel 12 is an example of a support member. The cover 40 is an example of a protective member. In the above description, the case in which the cover 40 is formed entirely of a material nearly transparent has been described, but the present invention is not limited thereto. The cover 40 may be formed of a smoky material or the like as long as it can guide light.

The cover 40 is formed entirely of a material nearly transparent. Therefore, the light of the image displayed by the display panel 30 passes through the hole 11, reaches the cover 40 and then can enter eyes of the driver. The cover 40 may be subjected to an optical treatment for suppressing reflection. In this case, the driver can visually recognize the image displayed by the display panel 30 well without being hindered by the reflection on the cover 40.

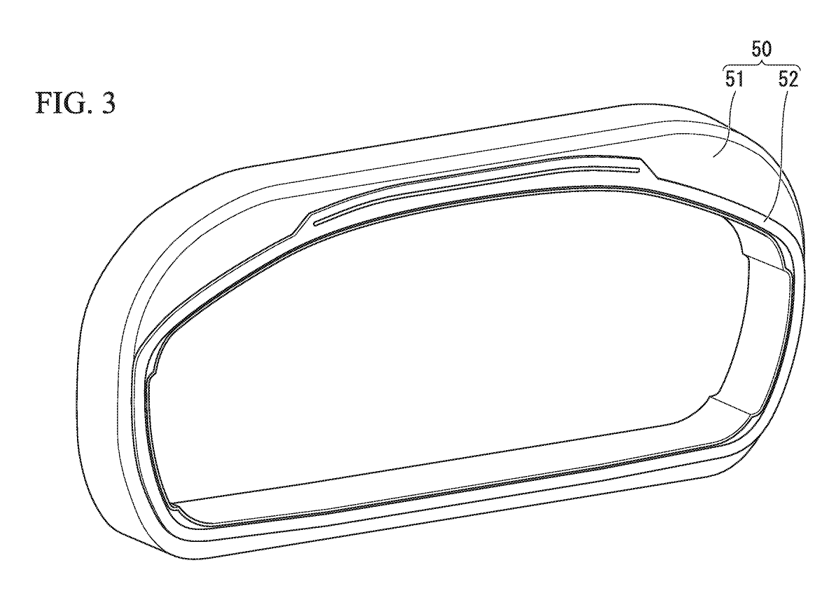

FIG. 3 is a view showing an example of the decorative portion 50 of the embodiment. For example, the decorative portion 50 is formed by combining two or more materials (a first material 51 and a second material 52 shown in the drawing) having different light absorption rates. In the example shown in FIG. 3, the first material 51 has a light absorption rate lower than that of the second material 52 and emits much radiated light. That is, the first material 51 emits light more brightly than that in the second material 52. The second material 52 emits light darker than that in the first material 51. It is possible to enhance a contrast of the edging of the display plate 10 and to further enhance the design of the display of the display device 1 by forming the decorative portion 50 with two or more materials.

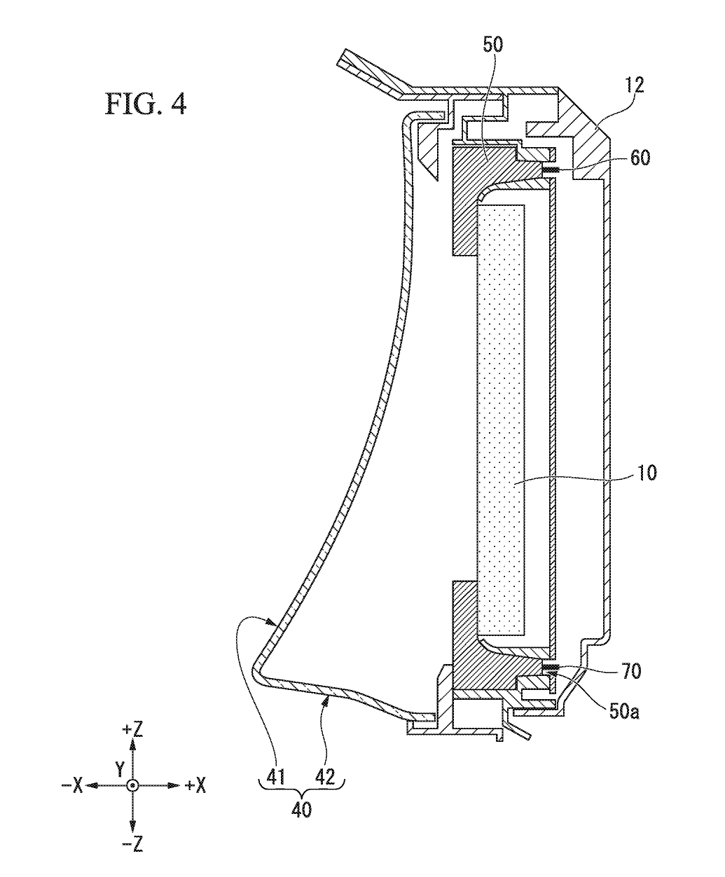

FIG. 4 is a cross-sectional view taken along line A-A′ in FIG. 1. The line A-A′ is a line passing through a center of the display plate 10 in the Y direction and is a line parallel to the Z direction. As shown in FIG. 4, the cover 40 covers the display plate 10 and the decorative portion 50. A surface portion 41 and a curved portion 42 are provided on the cover 40. The surface portion 41 is curved so that a center portion thereof is convex toward the display plate 10. Specifically, a surface of the surface portion 41 is recessed in the positive X direction, and a back surface of the surface portion 41 bulges in the positive X direction. The curved portion 42 extends from an outer circumferential edge of the surface portion 41 in a direction of the bezel 12. The curved portion 42 is fixed to the bezel 12. The cover 40 can suppress the light radiated to the cover 40 from being reflected by the surface portion 41 being curved, thereby preventing the driver's visibility of the display of the display device 1 from being hindered. In the above description, the case in which the surface portion 41 is curved has been described, but the present invention is not limited thereto. The surface portion 41 may be curved so that the center portion thereof is concave toward the display plate 10, or it may be curved with another curvature. The surface portion 41 may not be curved and may be flat.

As shown in FIG. 4, the light detector 70 is provided in contact with or in proximity to the tip end of the decorative portion 50. Proximity means that they face each other at an interval of, for example, a few [mm]. The light detector 70 detects the amount of light which is radiated on the decorative portion 50 and guided by the decorative portion 50. Light guiding means that light propagates through the interior formed by a thickness of the decorative portion 50 while being reflected by a surface of the decorative portion 50. The light radiated on the decorative portion 50 is, for example, external light that enters from a window glass of the vehicle or light diffusely reflected in a vehicle interior. Therefore, the light detector 70 detects an amount of external light that enters from a window glass of a driver's seat or an amount of light diffusely reflected in the vehicle interior. In the following description, a case in which the light detector 70 comes into contact with an end surface (hereinafter, an end surface 50a) of the decorative portion 50 will be described. In the example shown in FIG. 4, the decorative portion 50 protrudes from the display plate 10 in the X direction. Therefore, the decorative portion 50 can efficiently condense outside light that enters the window glass of the vehicle or light diffusely reflected in the vehicle interior (that is, external light) and can guide the light to the light detector 70.

Here, it is preferable that the light detector 70 be provided at a position in which it is difficult for the driver to visually recognize it. The position in which it is difficult for the driver to visually recognize it is, for example, a back surface side of the decorative portion 50. The back surface of the decorative portion 50 is a surface of the decorative portion 50 on the side opposite to the driver side and is a surface facing the bezel 12. As shown in FIG. 4, the irradiator 60 is provided in contact with or in proximity to the tip end of the decorative portion 50 and irradiates the decorative portion 50 with light.

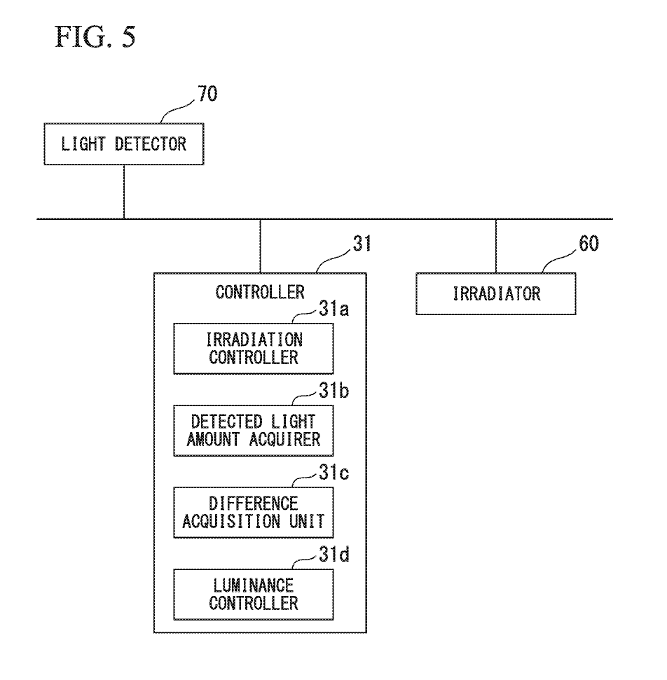

FIG. 5 is a diagram showing an example of a functional constitution of the controller 31 of the display device 1 according to the embodiment. The controller 31 is realized by a hardware processor such as a central processing unit (CPU) executing a program (software). The controller 31 includes, for example, an irradiation controller 31a, a detected light amount acquirer 31b, a difference acquisition unit 31c, and a luminance controller 31d as functional units thereof. Some or all of these constituent elements (excluding a built-in memory part) may be realized by hardware (including a circuit portion; including circuitry) such as a large scale integration (LSI), an application specific integrated circuit (ASIC), a field-programmable gate array (FPGA), or a graphics processing unit (GPU), or may be realized by software and hardware in cooperation. Description of a process of generating an image signal for displaying the image indicating the vehicle information on the display panel 30 by the controller 31 will be omitted.

The controller 31, the irradiator 60 and the light detector 70 are connected via a dedicated communication line or an internal bus so that information can be transmitted and received. The irradiation controller 31a controls the irradiator 60 to irradiate the decorative portion 50 with light. The irradiation controller 31a controls the irradiator 60 to irradiate the decorative portion 50 with light of a desired light amount, for example. The detected light amount acquirer 31b acquires information indicating an amount of light detected by the light detector 70.

Here, when the decorative portion 50 is irradiated with light by the irradiator 60, the amount of the light radiated by the irradiator 60 is superimposed on the detection result of the light detector 70. The difference acquisition unit 31c acquires a value obtained by subtracting the amount of light radiated by the irradiator 60 from the detection result detected by the light detector 70, for example. Specifically, the difference acquisition unit 31c acquires the information indicating the detection result detected by the light detector 70 from the detected light amount acquirer 31b, acquires the information indicating the amount of light radiated on the decorative portion 50 from the irradiator 60 from the irradiation controller 31a and then acquires a value (hereinafter referred to as a first difference value) obtained by subtracting the amount of light radiated on the decorative portion 50 by the irradiator 60 from the amount of light detected by the light detector 70.

When the decorative portion 50 is not irradiated with light by the irradiator 60, the luminance controller 31d changes a luminance of the display panel 30 on the basis of the detection result of the light detector 70 acquired by the detected light amount acquirer 31b and light amount luminance correspondence information. When the decorative portion 50 is irradiated with light by the irradiator 60, the luminance controller 31d changes a luminance of the display panel 30 on the basis of the first difference value acquired by the difference acquisition unit 31c and the light amount luminance correspondence information. The light amount luminance correspondence information is information in which the amount of light detected by the light detector 70 is associated with the luminance (that is, the display luminance) of the display panel 30.

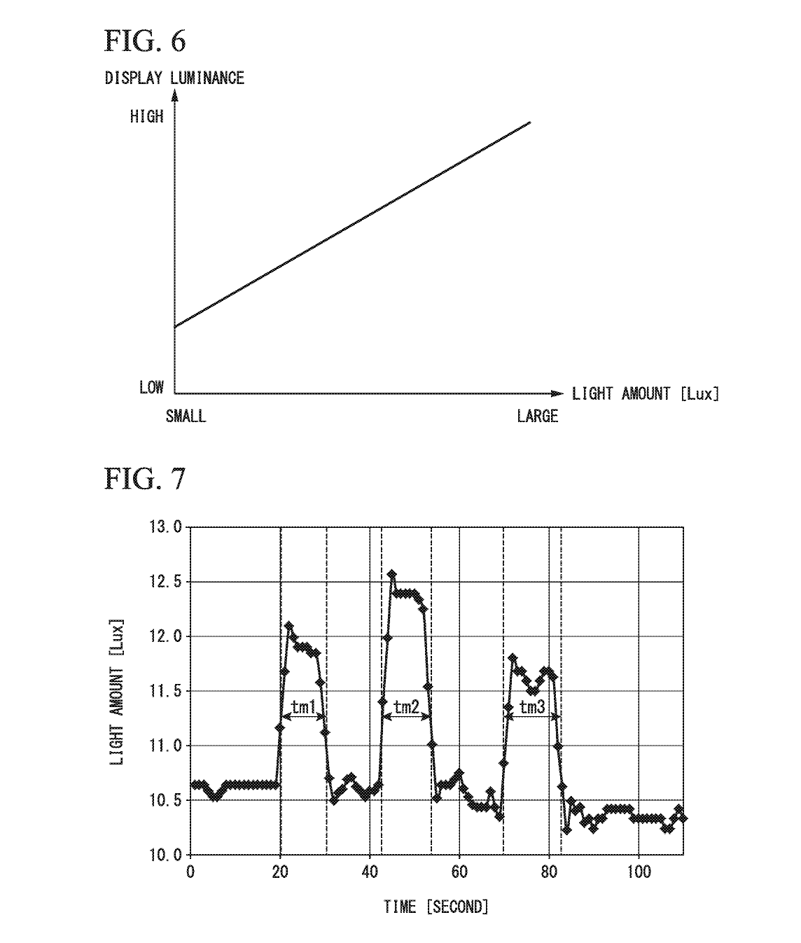

FIG. 6 is a diagram showing an example of the light amount luminance correspondence information of the embodiment. The light amount luminance correspondence information is associated with high luminance when the detection result of the light detector 70 indicates that the amount of light is large (that is, the surroundings of the display device 1 are bright) and is associated with low luminance when the detection result of the light detector 70 indicates that the amount of light is small (that is, the surroundings of the display device 1 are dark). Therefore, the controller 31 increases the luminance of the display panel 30 when the surroundings of the display device 1 are bright and decreases the luminance of the display panel 30 when the surroundings of the display device 1 are dark. The controller 31 may be constituted to control the display panel 30 to a predetected luminance even when the detection result of the light detector 70 indicates that light is not detected. The predetected luminance is a luminance at which the driver can visually recognize display content of the display panel 30 even when the surroundings of the display device 1 are dark.

FIG. 7 is a diagram showing an example of the detection result by the light detector 70 of the embodiment. Light is radiated on the display device 1 by a light emitting diode (LED) light or the like. Specifically, the display device 1 is irradiated with light for about 10 seconds (a period tm1 shown in the drawing) after 20 seconds have elapsed from start of the determination of the amount of light by the light detector 70, for about 10 seconds (a period tm2 shown in the drawing) after 42 seconds have elapsed and for about 10 seconds (a period tm3 shown in the drawing) after 58 seconds have elapsed. As shown in FIG. 7, the light detector 70 of the display device 1 can detect the light which is radiated on the cover 40 and guided by the decorative portion 50 in any period tm.

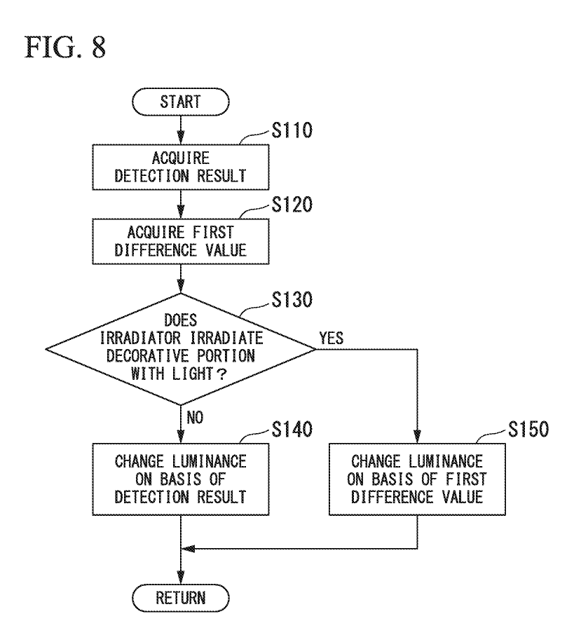

FIG. 8 is a flowchart showing an example of processing of the controller 31 according to the embodiment. The processing of this flowchart is repeated, for example. The detected light amount acquirer 31b acquires information indicating the detection result from the light detector 70 (Step S110). The difference acquisition unit 31c acquires the first difference value on the basis of the amount of light detected by the light detector 70 and the amount of light radiated to the decorative portion 50 by the irradiator 60 (Step S120). The luminance controller 31d changes the luminance of the display panel 30 on the basis of a control state of the irradiation controller 31a (Step S130). When the irradiator 60 does not radiate the decorative portion 50 with light, the luminance controller 31d changes the luminance of the display panel 30 on the basis of the information indicating the detection result of the light detector 70 acquired by the detected light amount acquirer 31b and the light amount luminance correspondence information (Step S140). When the irradiator 60 radiates the decorative portion 50 with light, the luminance controller 31d changes the luminance of the display panel 30 on the basis of the first difference value acquired by the difference acquisition unit 31c and the light amount luminance correspondence information (Step S150).

### Summary of Embodiment

As described above, the display device 1 of the embodiment includes the display (the display panel 30), the decorative portion 50 which covers an outer circumferential portion of the display, and the light detector 70 which is provided in contact with or in proximity to the decorative portion 50 and detects the amount of light guided by the decorative portion 50. Here, in the constitution in which the light detector 70 light at a pinpoint, it may be difficult to accurately detect the amount of ambient light even when the amount of the ambient light is large (bright), like a case in which the light detector 70 is shadowed. In the display device 1 of the embodiment, the light detector 70 detects light which is irradiated on the decorative portion 50 and guided by the decorative portion 50. Therefore, the light detector 70 of the display device 1 according to the embodiment can detect the light radiated on the decorative portion 50 and can detect the amount of ambient light more accurately.

The display panel 30 of the display device 1 of the embodiment displays an image (in this example, an image indicating the number of revolutions of an engine) which is recognized as a vehicle meter. Here, the surrounding environment of the vehicle changes sequentially according to movement of the vehicle. According to the display device 1 of the embodiment, it is possible to detect the light in the surrounding environment of the vehicle which changes sequentially.

The display device 1 of the embodiment further includes the controller 31 (the luminance controller 31d) which changes the luminance of the display panel 30 on the basis of the detection result of the light detector 70. According to the display device 1 of the embodiment, it is possible to change the luminance of the display panel 30 according to the light in the surrounding environment of the vehicle which changes sequentially and to adjust the display so that the display can be easily seen by the driver.

The display panel 30 of the display device 1 of the embodiment is mounted together with a mechanical display mechanism (the analog meter 20). Here, the reflectance of light may be different between the analog meter 20 and the display panel 30. Specifically, in the analog meter 20 and the display panel 30, the display panel 30 has higher reflectance of light. From the viewpoint of ease of visual recognition by the driver, it is preferable that the luminance of the display panel 30 be adjusted to approximately the same level as the luminance of the display device 1 (the analog meter 20). According to the display device 1 of the embodiment, even when the analog meter 20 and the display panel 30 which respectively have different reflectance are mounted together, it is possible to appropriately control the luminance of the display panel 30, that is, to alleviate the difficulty in viewing the display panel 30 emphasized by being mounted together with the analog meter 20.

The decorative portion 50 of the display device 1 of the embodiment protrudes to the outside from the display surface of the display panel 30. Therefore, outside light is more easily incident on the decorative portion 50. The light detector 70 of the display device 1 of the embodiment can detect the light in a planar manner by the decorative portion 50 and can detect an amount of surrounding light more accurately.

The display device 1 according to the embodiment further includes the irradiator 60 which radiates the decorative portion 50 with light, causes the decorative portion 50 and thereby emit light and decorates the display surface of the display panel 30. Thus, the display device 1 of the embodiment can improve an exterior of the display device 1, that is, a design thereof.

In the display device 1 of the embodiment, the luminance controller 31d changes the luminance of the display panel 30 on the basis of the value which is acquired by the difference acquisition unit 31c and obtained by subtracting the amount of light radiated by the irradiator 60 from the detection result detected by the light detector 70 when the irradiator 60 irradiates the decorative portion 50 with light. As described above, here, when the decorative portion 50 is irradiated with light by the irradiator 60, the amount of light radiated by the irradiator 60 is superimposed on the detection result of the light detector 70. According to the display device 1 of the embodiment, the luminance of the display panel 30 can be changed in consideration of the amount of light radiated by the irradiator 60 so that the display can be adjusted to be easily seen by the driver.

In the display device 1 of the embodiment, the light detector 70 is provided on the back surface side of the decorative portion 50. Thus, in the display device 1 of the embodiment, it is possible to improve the exterior of the display device 1, that is, the design thereof by providing the light detector 70 at a position of the decorative portion 50 which is difficult to be seen by the driver.

In the above description, the case in which the decorative portion 50 is mounted to surround at least a part of an outer circumferential portion of the display plate 10 in the Z-Y plane has been described, but the present invention is not limited thereto. The decorative portion 50 may not surround the outer circumferential portion of the display plate 10 as long as the decorative portion 50 is mounted to decorate the display device 1. The decorative portion 50 may be mounted as the ring 21 of the analog meter 20, for example, and may decorate the display of the analog meter 20. The decorative portion 50 may have a shape which surrounds the image display region 301 of the display panel 30, may be mounted at a position which coincides with the image display region 301 and may decorate the display of the display panel 30. Thus, the decorative portion 50 can improve the design of the display of the display device 1. The shape and the mounting position of the decorative portion 50 described above are merely examples, and the present invention is not limited thereto.

In the above description, the case in which the difference acquisition unit 31c acquires the value obtained by subtracting the amount of light radiated on the decorative portion 50 by the irradiator 60 from the amount of light detected by the light detector 70 as the first difference value has been described, but the present invention is not limited thereto. Here, the amount of light (hereinafter, referred to as an image light) which is radiated when the display panel 30 displays an image is superimposed on the detection result of the light detector 70. For example, the difference acquisition unit 31c may acquire a value obtained by subtracting the amount of light radiated on the decorative portion 50 by the irradiator 60 and the amount of the image light from the amount of light detected by the light detector 70 as the first difference value.

In this case, the display device 1 controls at least one of the luminance of the irradiator 60 and the luminance of the display panel 30 on the basis of the first difference value. Therefore, according to the display device 1, it is possible to adjust the luminance of the irradiator 60 or the display panel 30 in consideration of the luminance of the irradiator 60 and the luminance of the image light of the display panel 30 so that the display can be easily seen by the driver.

In the above description, the case in which the display device 1 includes the display plate 10, the analog meter 20, and the display panel 30 has been described, but the present invention is not limited thereto. For example, the display device 1 may not include the display panel 10 and the analog meter 20, but an entire surface thereof may be constituted with the display plate 30. In this case, the vehicle information indicated by the analog meter 20 is also indicated by the image displayed on the display panel 30.

### MODIFIED EXAMPLE

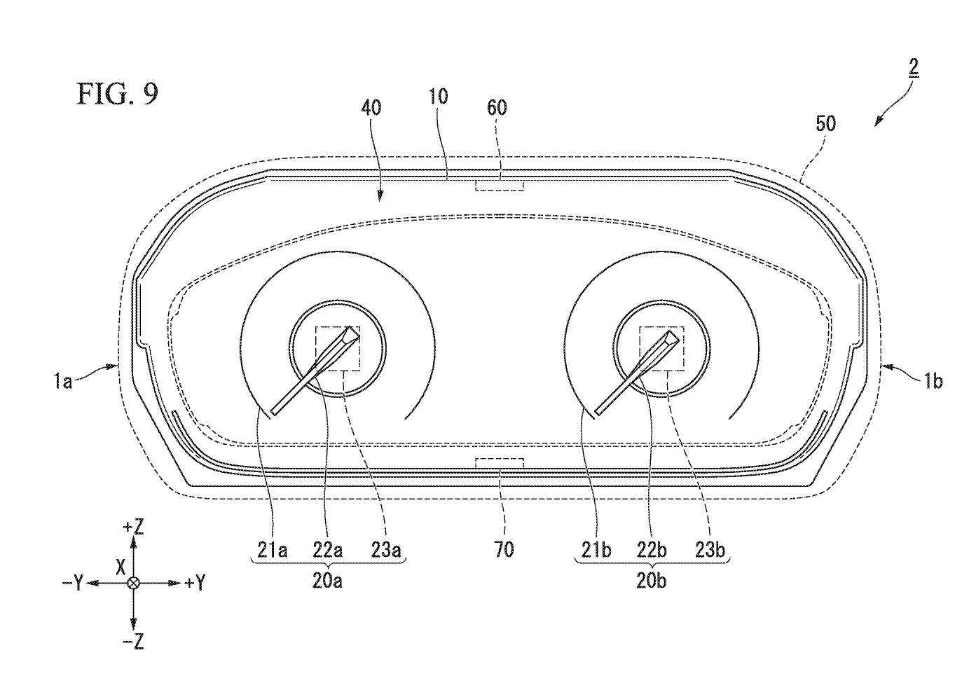

Hereinafter, a modified example of the embodiment will be described with reference to the drawing. FIG. 9 is a front view of a display device 2 according to a modified example. In the embodiment, the case in which the display device 1 includes the analog meter 20 and the display panel 30 has been described, but in the modified example, a case in which the display device 2 does not include the analog meter 20 and the display panel 30 but includes only the analog meter 20 will be described. Constituent elements similar to those of the above-described embodiment are designated by the same reference numerals, and description thereof will be omitted.

In the example shown in FIG. 9, the display device 2 does not include the display panel 30 and includes only the analog meter 20 (an analog meter 20a and an analog meter 20b shown in the drawing).

The analog meter 20a is provided on the left side as seen by the driver, and the analog meter 20b is provided on the right side as seen by the driver. The analog meter 20a includes, for example, a ring 21a, a pointing needle 22a, and a actuator 23a. The analog meter 20b includes a ring 21b, a pointing needle 22b, and a actuator 23b. Since the control in which each of the analog meter 20a and the analog meter 20b indicate the vehicle information is the same as the above-described control, the description thereof will be omitted. In the following description, when the analog meter 20a and the analog meter 20b are not distinguished from each other, they are collectively referred to as the analog meter 20. Instead of the constitution including the two analog meters 20, the display device 2 may be constituted to include one analog meter 20 or may be constituted to include two or more analog meters 20.

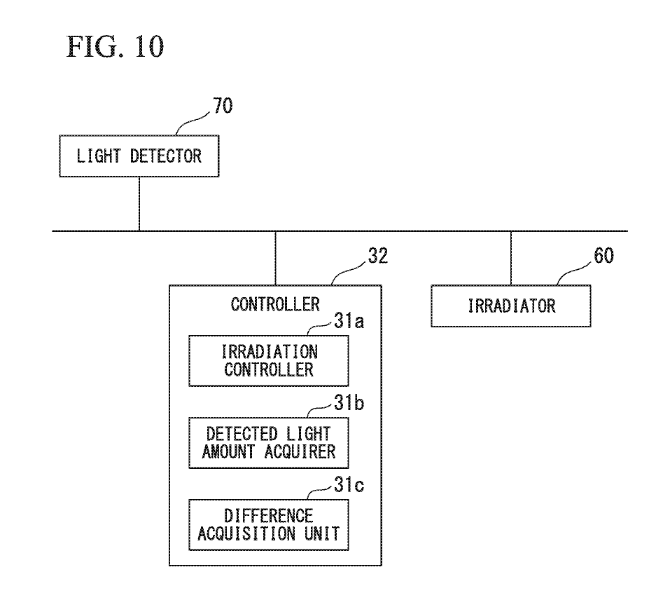

FIG. 10 is a diagram showing an example of a functional constitution of a controller 32 of the display device 2 according to the modified example. The controller 32, the light detector 70 and the irradiator 60 are connected via a dedicated communication line or an internal bus so that information can be transmitted and received. The controller 32 includes, for example, an irradiation controller 31a, a detected light amount acquirer 31b, and a difference acquisition unit 31c as functional units thereof. The irradiation controller 31a controls the irradiator 60 to radiate light. The irradiation controller 31a controls the irradiator 60 to radiate light of a desired light amount, for example. The detected light amount acquirer 31b acquires information indicating an amount of light detected by the light detector 70.

Here, when the decorative portion 50 is irradiated with light by the irradiator 60, the amount of light radiated by the irradiator 60 is superimposed on the detection result of the light detector 70. The difference acquisition unit 31c acquires a value obtained by subtracting the amount of light radiated by the irradiator 60 from the detection result detected by the light detector 70. Specifically, the difference acquisition unit 31c acquires information indicating the detection result detected by the light detector 70 from the detected light amount acquirer 31b, acquires the information indicating the amount of light radiated by the irradiator 60 from the irradiation controller 31a and then acquires a value (hereinafter, referred to as a second difference value) obtained by subtracting the amount of light radiated by the irradiator 60 from the amount of light detected by the light detector 70.

When the irradiator 60 is not irradiated with light, the irradiation controller 31a changes the luminance of the irradiator 60 on the basis of the detection result of the light detector 70 acquired by the detected light amount acquirer 31b and the light amount luminance correspondence information. When the irradiator 60 is irradiated with light, the irradiation controller 31a changes the luminance of the irradiator 60 on the basis of the second difference value acquired by the difference acquisition unit 31c and the light amount luminance correspondence information.

The light amount luminance correspondence information is information in which the amount of light or the second difference value detected by the light detector 70 is associated with the luminance of the irradiator 60. Specifically, when the detection result of the light detector 70 or the second difference value indicates that the amount of light is high (that is, the surroundings of the display device 2 are bright), the light amount luminance correspondence information is associated with high luminance, and when the detection result of the light detector 70 or the second difference value indicates that the amount of light is small (that is, the surroundings of the display device 2 are dark), the light amount luminance correspondence information is associated with low luminance

Therefore, the controller 32 increases the luminance of the light radiated by the irradiator 60 when the surroundings of the display device 2 are bright and decreases the luminance of the light radiated by the irradiator 60 when the surroundings of the display device 2 are dark. The controller 31 may be constituted to control the irradiator 60 to a predetected luminance even when the detection result of the light detector 70 indicates that light is not detected. The predetected luminance is a luminance at which the driver is not hindered from visually recognizing the analog meter 20.

In the above description, the case in which the irradiation controller 31a controls the luminance of the light radiated by the irradiator 60 on the basis of the second difference value when the irradiator 60 radiates light has been described, but the present invention is not limited thereto. The irradiation controller 31a may control the luminance of the light radiated by the irradiator 60 on the basis of the detection result of the light detector 70, regardless of whether or not the irradiator 60 radiates light.

In this case, the controller 32 may not include the difference acquisition unit 31c.

A lighting method in which the irradiator 60 is turned on on the basis of the control of the irradiation controller 31a may be a dynamic lighting method or a static lighting method. When the irradiator 60 is turned on by the dynamic lighting method, the irradiator 60 is turned on by repeating the turning on and off to an extent in which the driver constantly recognizes the light emission.

Although the embodiment of the present invention has been described in detail with reference to the drawings, the specific configuration is not limited to this embodiment, and appropriate modifications can be made without departing from the spirit of the present invention. The constitutions described in the above embodiments may be combined.

What is claimed is:

1. A display device comprising:
a display,
a decorative portion which decorates the display, and
a light detector which is provided in contact with or in proximity to the decorative portion and is configured to detect an amount of light guided by the decorative portion.

2. The display device according to claim 1, wherein the display is configured to display an image recognized as a vehicle meter.

3. The display device according to claim 1, further comprising a controller which is configured to change a luminance of the display on the basis of a detection result of the light detector.

4. The display device according to claim 2, further comprising a controller which is configured to change a luminance of the display on the basis of a detection result of the light detector.

5. The display device according to claim 1, wherein the display is mounted together with a mechanical display mechanism.

6. The display device according to claim 1, wherein the display includes a mechanical display mechanism and is configured to display a physical quantity relating to a traveling state of a vehicle.

7. The display device according to claim 1, wherein the decorative portion protrudes outward from a display surface of the display.

8. The display device according to claim 1, further comprising an irradiator which is configured to irradiate the decorative portion with light and thereby emit light and decorate a display surface of the display.

9. The display device according to claim 8, further comprising a difference acquisition unit which is configured to acquire a value obtained by subtracting an amount of light radiated by the irradiator from the detection result detected by the light detector as an amount of external light.

10. The display device according to claim 1, wherein the light detector is provided on a back surface side of the decorative portion.

11. A mounting structure of a vehicle meter, wherein a decorative portion configured to decorate a display is mounted, and
a light detector configured to detect an amount of light guided by the decorative portion is provided in contact with or in proximity to a back surface of the decorative portion.
